(19) United States
(12) Patent Application Publication
(10) Pub. No.: US 2024/0422105 A1
(43) Pub. Date: Dec. 19, 2024

(54) SYSTEMS AND METHODS FOR MANAGING NETWORK TRAFFIC

(71) Applicant: Microsoft Technology Licensing, LLC, Redmond, WA (US)

(72) Inventors: Mukund RAMAKRISHNA, Austin, TX (US); Keshav RAHEJA, Morrisville, NC (US)

(21) Appl. No.: 18/336,479

(22) Filed: Jun. 16, 2023

(51) Int. Cl. H04L 47/30; H04L 47/12

(52) U.S. Cl. CPC H04L 47/30; H04L 47/12

(57) ABSTRACT

Embodiments of the present disclosure include techniques for managing network traffic. Congestion in queues between a source and destination may be detected. A queue with congestion may be elevated. Elevated queues may signal downstream queues that congestion is occurring. Elevated queues may have weights increased so that the queue can send more packets to an output port than other queues coupled to the output port during periods of congestion.

### BACKGROUND

The present disclosure relates generally to computer networks, and in particular, to systems and methods for managing network traffic.

Computer networking is a technology that allows different computers or compute elements to communicate information with each other over various forms of interconnects. Example interconnects include routers, links, and interfaces that enable data communication among various forms on data processing blocks. Interconnects can support various network topologies, such as mesh, ring, tree, or custom topologies.

One example form of computer networking is a network-on-chip (NoC). NoC interconnects use a network-like structure to connect different data processing blocks on a system-on-chip (SoC), which may include multiple compute blocks (e.g., data processors, such as microprocessors or accelerators). NoC interconnects can provide higher performance, lower power, good scalability, and easier design reuse for complex SoCs. Routers on an NoC perform routing functions based on the network topology and protocols. The links are wires that connect the routers and carry payload packets. The interfaces are adapters that translate between the data processing protocols and the network protocols.

One important issue to the performance of interconnect networks is the technique of arbitration. Arbitration is the process of resolving conflicts or requests for access to shared resources in an interconnect network. Arbitration is important for networking, and particularly to NoC interconnects, because it affects the performance, efficiency, and reliability of the system. Different arbitration schemes can have different impacts on the throughput, latency, and power consumption.

Traditional arbitration schemes may not be efficient when traffic patterns are unpredictable. Real-world applications can have bursty traffic that is spread unevenly across the system. In some cases, unpredictable traffic may create unnecessary network hotspots which can negatively impact power and performance. Traditional approaches to arbitration may not be able to adapt to these changing traffic patterns.

The following disclosure includes improved techniques for addressing these and other issues.

### BRIEF DESCRIPTION OF THE DRAWINGS

FIG. 1 illustrates an example system for managing network traffic according to an embodiment.

FIG. 2 illustrates an example method processing packets in a network according to an embodiment.

FIG. 3 illustrates an example of elevating the status of a queue according to an embodiment.

FIG. 4 illustrates another example of elevating the status of a queue according to an embodiment.

FIG. 5 illustrates an example of increasing weights of a queue according to an embodiment.

FIG. 6 illustrates an example signaling a downstream router according to an embodiment.

FIG. 7 illustrates an example of elevating the status of a queue based on packets directed at a particular downstream node output according to an embodiment.

FIG. 8 illustrates network traffic in an example network according to an embodiment.

FIG. 9 illustrates a crossbar router node.

### DETAILED DESCRIPTION

Described herein are techniques for moving data between components of a system. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Features and advantages of the present disclosure include a mechanism to arbitrate network traffic such that packets move across a network more efficiently.

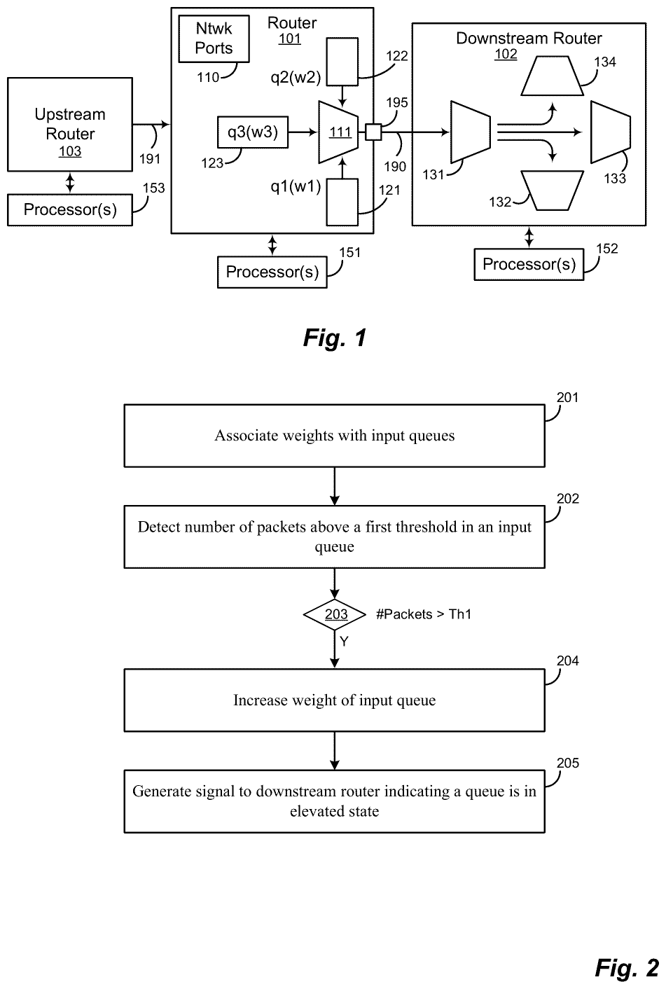

FIG. 1 illustrates an example system for managing network traffic according to an embodiment. Features and advantages of the present disclosure include a networking techniques to improve network efficiency by identifying parameters of particular queues and changing how a queue transfers information to an output based on such parameters. Embodiments of the techniques described herein may be implemented on a variety of network topologies, such as a mesh network, a ring network, a tree network, for example, or a variety of other networks. In some embodiments, the network is an N-dimensional mesh network, wherein N is an integer greater than 2 (e.g., a 2D network or 3D network). An illustrative system is shown in FIG. 1, which illustrates a plurality of routers 101-103 coupled together by network connections 190 and 191. Routers are, generally, network devices that move data between terminals of the device so information flows through a network from a source to a destination. Router 101, for example, includes a plurality of network ports 110 (e.g., port 111) coupled to a plurality of network connections 190 and 191. Network connections are coupled to a plurality of other routers (e.g., routers 102 and 103). A router typically receives data on one port (or from one or more local processors) and routes the data to another router port to move the data to a destination. Routers are sometimes also referred to as network switches, for example.

Routers 101-103 may each be coupled to one or more processors 151-153. Processors 151-153 may be a wide variety of data processors, such as microprocessors, AI accelerators, graphics processors, or other forms or computer devices. Processors 151-153 are sometimes referred to as clients. Accordingly, routers 101-103 communicate data between processors 151-153 to perform a wide variety of functions.

While routers 101-103 are illustrated as being coupled together using arrows for network connections 190 and 191, it is to be understood that network connections 190 and 191 are typically bidirectional. Accordingly, data may flow in the opposite direction as the arrows 190 and 191. However, arrows are used to illustrate an example flow of data (e.g., packets) from router 103 to router 101, and from router 101 to router 102. Accordingly, router 103 is “upstream” of router 101 and router 102 is “downstream” of router 101 for the illustrated data flow: In various embodiments, processors 151-153, router 101, downstream router 102, and the upstream router 103 are on a system-on-chip (SoC) comprising a plurality of processors coupled over a network by a plurality of routers. The network formed may be a network-on-chip (NoC), for example.

Features and advantages of the present disclosure include routers in a network that execute a data congestion algorithm. The algorithm may perform dynamic arbitration to alleviate network congestion, for example. In various embodiments, queues are monitored and placed in an “elevated” status to enhance the flow of packets through the network. Router 101 may include a plurality of input queues 121-123 that provide packets to an output port 195. In this example, packets in queues 121-123 are illustrated as flowing through a multiplexer (MUX) 111, which selectively couples packets from queues 121-123 to output port 195, network connection 190, and downstream router 102, for example. Each queue 121-123 may have associated weights w1, w2, and w3 (e.g., a queue, q, is denoted here as having weights, w, as follows: q1(w1), q2(w2), and q3(w3)). Data packets in input queues 121-123 are coupled from the input queues to the output port 195 based on the weights. A number of packets in the input queues 121-123 is monitored.

Packets in particular queues may be prioritized using a variety of techniques. In one embodiment, when the system detects a number of packets in an input queue is above a first threshold, the queue may be referred to as elevated, and a weight associated with the input queue may be increased. In another embodiment, router 101 may detect a signal from upstream router 103 indicating that the upstream router has a number of packets in an upstream router input queue (e.g., destined for the same downstream queue) above an upstream router threshold. In this case, the input queue receiving packets from the upstream router may be elevated. In some embodiments, router 101 may detect when a number of packets in an input queue, which are directed to a particular input queue of downstream router 102 (e.g., an input queue couple to MUX 134), is above a second threshold. When this state is detected, a signal is generated to the downstream router to increase a weight associated with the particular input queue of the downstream router. The input queue in router 101 may not be in an elevated state (e.g., the second threshold is less than the first threshold) when the signal is sent. In some embodiments, the signals indicating packet congestion in a queue that are sent between routers may be sent using a variety of techniques. For example, in some embodiments, the signal may be embedded in a packet (e.g., as one or more bits). In other embodiments, the signal may be sent to another router using another channel, for example, such as separate wires.

In some embodiments, when a queue is elevated, a signal is generated to the downstream router 102. The signal may be a warning that router 101 is experiencing congestion so downstream router 102 may be configured to handle the increase in the number of packets, for example. Accordingly, using one or more of the above techniques, congestion may be detected and traffic priorities may be modified with advanced notice propagating forward through the network to handle increases of data flow between a source and destination.

For example, in one embodiment, the data packets in input queues 121-123 are coupled from the input queues to output port 195 using a weighted round robin algorithm. According to one example implementation of a weighted round robin algorithm, each input queue has an associated integer weight and each input queue, in succession, forwards a packet through MUX 111 (e.g., one packet from queue 121, then one packet from queue 122, then one packet from queue 123, and then one packet from queue 121 again, and so on). As each queue sends a packet, the queue's associated weight may be reduced by 1. When queues reach zero, they stop transmitting until other queues with non-zero weights decrement to zero. When all queues reach zero, the weights are reset to their initial values. Accordingly, using this approach, queues with higher weights transmit packets more than queues with lower weights. When a queue is elevated, a weight for the queue may be increased such that the queue will be able to forward more packets to an output port during each round robin cycle. In particular, an elevated queue may have its weights increased by adding a predetermined number of weights associated with the input queue when a value of a weight initially associated with the input queue goes to zero. Further examples of the present techniques are described in more detail below.

FIG. 2 illustrates an example method processing packets in a network according to an embodiment. At 201, weights are associated with a corresponding plurality of input queues to an output port of a router. The output port may couple the router to a downstream router over a network connection, for example. Data packets in input queues are coupled from the input queues to the output port based on the weights (e.g., using a weighted round robin arbitration scheme). At 202, the system detects when a number of packets in a first input queue of a plurality of input queues to an output port is above a first threshold. When the number of packets in the first input queue is above the first threshold at 203, the system increases a weight associated with the first input queue. The queue is said to be elevated. In some embodiments, the system generates a signal to the downstream router at 205. The signal may indicate that a queue is in an elevated state so the downstream router has an early warning of the congestion. An input queue of the downstream router may receive the signal and enter an elevated state, thereby propagating the elevated state forward in the network to advantageously handle the increased data flow:

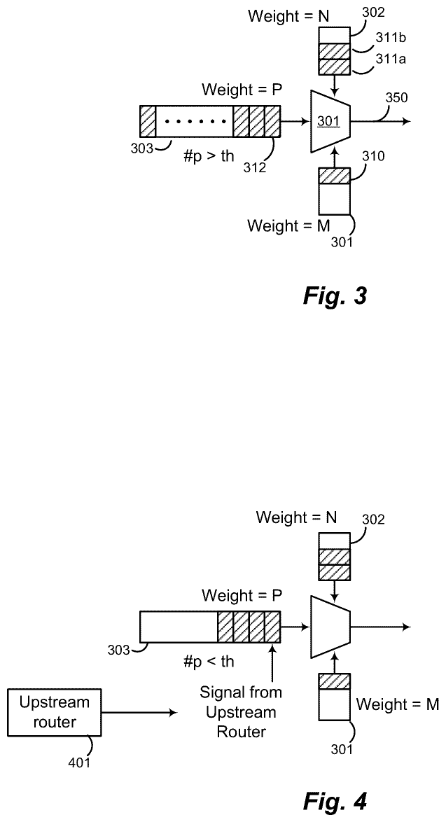

FIG. 3 illustrates an example of elevating the status of a queue according to an embodiment. In this example, an output port 350 receives packets from three (3) input queues 301-303. Queue 301 has one packet 310 (packets are shaded) and an associated weight M. Similarly, queue 302 has two packets 311a-b and an associated weight N. Finally, queue 303 includes many packets, such as packet 312 and an associated weight P, where M, N, and P are integers greater than one in this example. It is to be understood that a variety of other weighted arbitrations schemes could use the techniques presented herein. In this case, the number of packets (#p) in queue 303 has increased above a first threshold (#p>th). This threshold may be referred to as the local alleviation threshold, for example. Accordingly, queue 303 is placed in an elevated status.

FIG. 4 illustrates another example of elevating the status of a queue according to an embodiment. In this case, queues 301-303 all have a number of packets less than the first threshold. However, queue 303 receives a signal from an upstream router 401. Accordingly, queue 303 is placed in an elevated status.

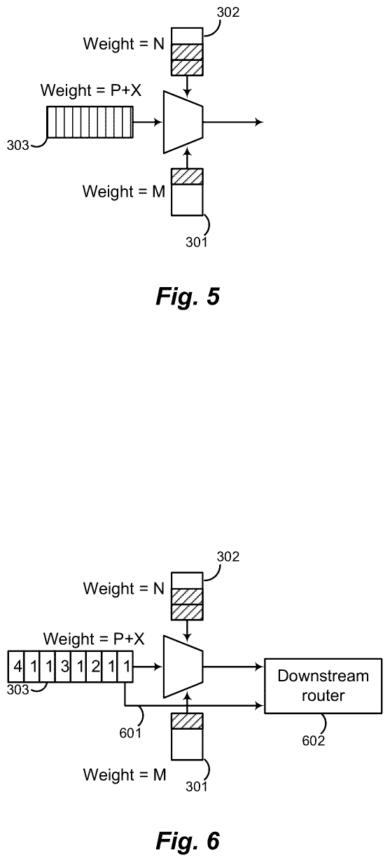

FIG. 5 illustrates an example of increasing weights of a queue according to an embodiment. When a queue is in an elevated status, the priority of the queue is increased. In this example, queue 303 is in an elevated status. Therefore, weights associated with queue 303 have been increased (e.g., P+X, where P is the original value of the weights and X is an integer increase in the weights). In a weighted round robin arbitration scheme, as just one example, increasing the weights of queue 303 allows packets in queue 303 to continue transmitting to the output port before a reset occurs (all queue weights are reset to their initial values) after queues 301-302 have exhausted their weights. As mentioned above, a variety of weighted arbitrations schemes may be used to prioritize traffic of an elevated queue.

FIG. 6 illustrates an example signaling a downstream router according to an embodiment. Once a queue, such as queue 303, is marked ‘elevated’, an early ‘warning’ signal 601 is triggered to the next node 602 if the number of packets landing in queue 303 is deemed greater than a threshold (‘next node alleviation threshold_1’). In the example shown here, the numbered packets (e.g., 1, 2, 3, 4) represent a unique output direction in downstream router 602. Packets having the same number will be assigned to the same queue in the downstream router 602. For example, packets with a ‘1’ may be assigned to a queue coupled to one output port, packets with a ‘2’ may be assigned to a queue coupled to a second output port, packets with a ‘3’ may be assigned to a queue coupled to a third output port, and packets with a ‘4’ may be assigned to a queue coupled to a fourth output port. In an example case, if queue 303 is elevated, and the count of packets designated as ‘1’ exceeds the ‘next node alleviation threshold_1’, a signal is issued to alert the queue ‘3’ on router 602, marking it ‘elevated’ (where packets marked as ‘1’ in queue 303 on router 601 are received by queue 3 on router 602). After queue ‘3’ on router 602 is raised to ‘elevated’ status, it will count the number of packets intended for each direction (e.g., N, S, E, W), with one counter assigned to each direction. If any of the counters hit a ‘next node alleviation threshold_1’, a signal will be transmitted downstream for that input queue to alert the system. Moreover, router 602 may modify the arbiter weights that have been depleted in a dynamic manner.

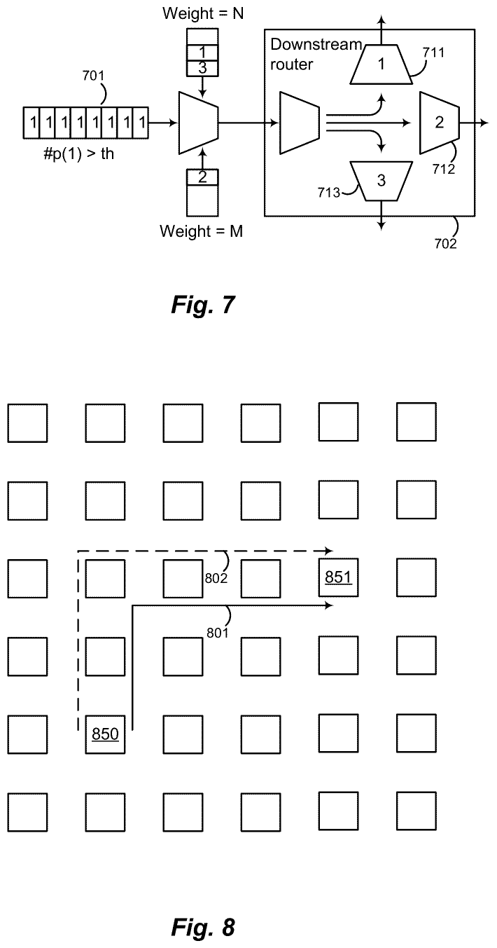

FIG. 7 illustrates an example of elevating the status of a queue based on packets directed at a particular downstream node output according to an embodiment. In this case, queue 701 may not qualify as ‘elevated’ because it has not met the packet threshold (e.g., #p>th above) nor has it received a ‘warning signal’ from the previous node. However, this queue is experiencing a significant build-up of packets directed toward the same destination (e.g., through output MUX 711 in downstream router 702). Each router may determine a subsequent destination node and queue to establish whether the packets are intended for the same queue on the same router. Accordingly, a second threshold is used to avoid build-up in subsequent queues, and an advance notification signal is generated using a second threshold. Accordingly, even if not elevated, an early ‘warning’ signal is triggered to the next node if the number of packets landing there is deemed greater than a second threshold (‘next node alleviation threshold_2’). In particular, an input queue to MUX 711 that receives packets ‘1’ in queue 701 may receive the signal and be placed in an elevated state. The second threshold may be less than the first threshold so that congestion of packets to the same destination may trigger downstream warnings before the first threshold is met.

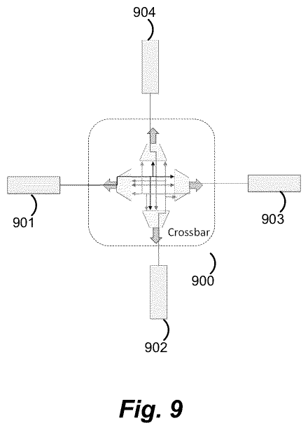

FIG. 8 illustrates network traffic in an example network according to an embodiment. In this example, the squares represent nodes (e.g., processors and routers) coupled together in a 2D network. FIG. 9 illustrates a crossbar router node 900 represented by the squares in FIG. 8. Each node has 4 I/O network connections 901-904. Packets received on any of nodes 901-904 can be routed to be output on any other node 901-904, and hence to another neighboring node. In this example, a source node 850 sends packets to a destination node 851. An example path is shown by 801. However, as packets start propagating through the network, congestion may occur (e.g., if source node 850 is sending a large amount of data to destination node 851. Accordingly, warning signals 802 will be sent along path 801 to place various queues in the nodes along the path in an elevated state to increase the weights of the queues along the path and thereby prioritize traffic between nodes 850 and 851. The prioritization is advantageously dynamic based on the detection of congestion as described above. Accordingly, prioritization and congestion alleviation may only occur when needed, automatically, when large payloads are sent between nodes. Additionally, the prioritization is automatically cleared when the above thresholds are no longer met, returning traffic management to a normal state. For example, in some embodiments, the decision to generate a warning downstream is made at every node (e.g., router) for the subsequent node (e.g., router) so as soon as congestion clears (e.g., the next_node_alleviation_threshold is no longer met) the warning signal is reset. Similar to generation, this communication can take on separate wires or piggy back on a packet destined for the queue, for example.

### Further Examples

Each of the following non-limiting features in the following examples may stand on its own or may be combined in various permutations or combinations with one or more of the other features in the examples below: In various embodiments, the present disclosure may be implemented as a system or method.

In one embodiment, the present disclosure includes a system comprising: one or more processors: a router coupled to the one or more processors, the router comprising a plurality of network connections to a plurality of other routers including a downstream router, wherein the router executes a data congestion algorithm comprising: associating a plurality of weights to a corresponding plurality of input queues to an output port of the router, the output port coupling the router to the downstream router, wherein data packets in the plurality of input queues are coupled from the plurality of input queues to the output port based on the weights: detecting when a number of packets in a first input queue of the plurality of input queues is above a first threshold; and when the number of packets in the first input queue is above the first threshold: increasing a first weight associated with the first input queue; and generating a signal to the downstream router.

In one embodiment, the present disclosure includes a method of processing packets in a network comprising: associating a plurality of weights to a corresponding plurality of input queues to an output port of a router, the output port coupling the router to a downstream router over a network connection, wherein data packets in the plurality of input queues are coupled from the plurality of input queues to the output port based on the weights: detecting when a number of packets in a first input queue of the plurality of input queues is above a first threshold; and when the number of packets in the first input queue is above the first threshold: increasing a first weight associated with the first input queue; and generating a signal to the downstream router.

In one embodiment, the data congestion algorithm or method further comprises detecting, in the router, a signal from an upstream router indicating that the upstream router has a second number of packets in an upstream router queue above an upstream router threshold.

In one embodiment, the one or more processors, the router, the downstream router, and the upstream router are on a system-on-chip comprising a plurality of processors coupled over a network by a plurality of routers.

In one embodiment, the data congestion algorithm or method further comprises detecting, in the router, when a number of packets, directed to a particular input queue of the downstream router, in one of the plurality of input queues is above a second threshold, and in accordance therewith, generating a signal to the downstream router to increase a weight associated with the particular input queue of the downstream router.

In one embodiment, the second threshold is less than the first threshold.

In one embodiment, the data packets in the plurality of input queues are coupled from the plurality of input queues to the output port using a weighted round robin algorithm.

In one embodiment, said increasing a first weight comprises adding a predetermined number of weights associated with the first input queue when a value of a weight initially associated with the first input queue goes to zero.

In one embodiment, the network is one of: a mesh network, a ring network, and a tree network.

In one embodiment, the network is an N-dimensional mesh network, wherein N is an integer greater than 2.

In one embodiment, the router further comprising a plurality of counters, wherein a first portion of the counters count numbers of packets in the input queues.

In one embodiment, a second portion of the counters count numbers of packets associated with different output ports for counting packet directions.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A system comprising:
one or more processors:
a router coupled to the one or more processors, the router comprising a plurality of network connections to a plurality of other routers including a downstream router, wherein the router executes a data congestion algorithm comprising:
associating a plurality of weights to a corresponding plurality of input queues to an output port of the router, the output port coupling the router to the downstream router, wherein data packets in the plurality of input queues are coupled from the plurality of input queues to the output port based on the weights:
detecting when a number of packets in a first input queue of the plurality of input queues is above a first threshold; and
when the number of packets in the first input queue is above the first threshold:
increasing a first weight associated with the first input queue; and
generating a signal to the downstream router.

2. The system of claim 1, the data congestion algorithm further comprising detecting, in the router, a signal from an upstream router indicating that the upstream router has a second number of packets in an upstream router queue above an upstream router threshold.

3. The system of claim 2, wherein the one or more processors, the router, the downstream router, and the upstream router are on a system-on-chip comprising a plurality of processors coupled over a network by a plurality of routers.

4. The system of claim 1, the data congestion algorithm further comprising detecting, in the router, when a number of packets, directed to a particular input queue of the downstream router, in one of the plurality of input queues is above a second threshold, and in accordance therewith, generating a signal to the downstream router to increase a weight associated with the particular input queue of the downstream router.

5. The system of claim 4, wherein the second threshold is less than the first threshold.

6. The system of claim 1, wherein the data packets in the plurality of input queues are coupled from the plurality of input queues to the output port using a weighted round robin algorithm.

7. The system of claim 6, wherein said increasing a first weight comprises adding a predetermined number of weights associated with the first input queue when a value of a weight initially associated with the first input queue goes to zero.

8. The system of claim 1, wherein the network is one of: a mesh network, a ring network, and a tree network.

9. The system of claim 1, wherein the network is an N-dimensional mesh network, wherein N is an integer greater than 2.

10. The system of claim 1, the router further comprising a plurality of counters, wherein a first portion of the counters count numbers of packets in the input queues.

11. The system of claim 10, wherein a second portion of the counters count numbers of packets associated with different output ports for counting packet directions.

12. A method of processing packets in a network comprising:
associating a plurality of weights to a corresponding plurality of input queues to an output port of a router, the output port coupling the router to a downstream router over a network connection, wherein data packets in the plurality of input queues are coupled from the plurality of input queues to the output port based on the weights:
detecting when a number of packets in a first input queue of the plurality of input queues is above a first threshold; and
when the number of packets in the first input queue is above the first threshold:
increasing a first weight associated with the first input queue; and
generating a signal to the downstream router.

13. The method of claim 12, further comprising detecting, in the router, a signal from an upstream router indicating that the upstream router has a second number of packets in an upstream router queue above an upstream router threshold.

14. The method of claim 13, wherein the one or more processors, the router, the downstream router, and the upstream router are on a system-on-chip comprising a plurality of processors coupled over a network by a plurality of routers.

15. The method of claim 12, further comprising detecting, in the router, when a number of packets in one of the plurality of input queues, directed to a particular output port of the downstream router, is above a second threshold, and in accordance therewith, increasing a weight associated with the particular output port of the downstream router.

16. The method of claim 15, wherein the second threshold is less than the first threshold.

17. The method of claim 12, wherein the data packets in the plurality of input queues are coupled from the plurality of input queues to the output port using a weighted round robin algorithm.

18. The method of claim 17, wherein said increasing a first weight comprises adding a predetermined number of weights associated with the first input queue when a value of a weight initially associated with the first input queue goes to zero.

19. The method of claim 12, wherein the network is one of: a mesh network, a ring network, and a tree network.

20. The method of claim 12, wherein the network is an N-dimensional mesh network, wherein N is an integer greater than 2.
